(19) United States
(12) Patent Application Publication
(10) Pub. No.: US 2022/0248695 A1
(43) Pub. Date: Aug. 11, 2022

(54) Method for the preparation of a sausage mixture coating gel including high-pressure processing

(71) Applicant: SONJAL, Brie (FR)

(72) Inventor: Alain Tanguy, Janze (FR)

(21) Appl. No.: 17/667,931

(22) Filed: Feb. 9, 2022

(30) Foreign Application Priority Data
Feb. 9, 2021 (FR) 2101223

(51) Int. Cl. A22C 13/00; C09D 7/20; C09D 5/02; C09D 105/04; C09D 7/65; A23L 29/212; A23L 29/238; A23L 29/269; A23L 29/262; A23L 13/00

(52) U.S. Cl. CPC A22C 13/0013; C09D 7/20; C09D 5/024; C09D 105/04; C09D 7/65; A22C 2013/0023; A23L 29/238; A23L 29/27; A23L 29/262; A23L 13/03; A23V 2002/00; A23L 29/212

(57) ABSTRACT

A method for preparing an aqueous coating composition to be applied by co-extrusion around a food preparation and contacted with a gelling agent, such as calcium chloride, to form a shell around the food preparation. After mixing at least the water and the alginate of the composition, the mixture is exposed to a high pressure of at least 1400 bar, for example at least 1800 bar, for at least 0.1 second.

### CROSS-REFERENCE TO RELATED APPLICATION

This Application claims priority to and the benefit of French Patent Application No. FR2021/01223, filed Feb. 9, 2021, the content of which is incorporated herein by reference in its entirety.

### FIELD OF THE INVENTION

The invention relates to the field of food processing and more particularly to the processing of meat in the form of sausages.

More specifically, the invention relates to a method for preparing an aqueous coating composition to be applied by co-extrusion around a food preparation, a corresponding aqueous composition and a method for making a sausage. The invention is particularly suitable for the production of fresh, boiled or cooked sausages and dry sausages.

### STATE OF THE ART

For several years, there has been an attempt to replace animal-based sausage zo casings with plant-based casings, for technical, health and/or religious reasons. Vegetable sausage casings based on water, alginate and other poly-saccharides, such as starch, CMC (acronym for carboxymethyl cellulose), guar gum or cellulose derivatives are known, for example from patent applications FR2973988, EP1311165 or WO9955165. To form these casings, an aqueous gel composition is applied around the meat mixture, which forms a tough casing around the mixture after gelation of the gel.

These aqueous gels, which are obtained by simply mixing the different compounds, are difficult to work with on some co-extruders. For example, the envelope tears when trying to twist the envelope to ensure the closure of the ends of continuously produced sausages, one after the other.

Another disadvantage of using known gels is that the casing obtained after gelation of the gel tends to detach from the meat mixture, due to a lack of adhesion between the mixture and the casing. This detachment, which is accompanied by a deformation of the sausage, or even a tearing of the casing, is all the more pronounced when the sausages are cooked, which may put off some consumers.

In addition, there is now a growing demand for preservative-free sausages. However, it has been observed that if no preservative is used in the composition of known aqueous gels, bacteria and more generally microbial flora develop very quickly within a few days and proliferate within the gels, which very strongly limits the conservation capacity of the gels and consequently their interest in the context of industrial implementation.

### SUMMARY

An exemplary aspect of the present application relates to a method for preparing an aqueous coating composition intended to be applied by co-extrusion around a food preparation and brought into contact with a gelling zo agent, such as calcium chloride, in order to form an envelope around said food preparation, said composition essentially comprising water and 2 to 10 w/w % alginate.

In the context of an exemplary embodiment of the present application, the food preparation may be, for example, a meat preparation, a preparation suitable for a vegetarian diet or a cheese preparation. Furthermore, it may be a food preparation for human or animal consumption.

It should further be noted that in the context of an exemplary embodiment, the alginate may be sodium alginate, potassium alginate, ammonium alginate, calcium alginate or propane-1 ,2-diol alginate.

Finally, the water of the composition may be water from the drinking water network or demineralized or softened water, without going beyond the scope of an exemplary embodiment of the present application.

According to an exemplary embodiment, after mixing at least the water and the alginate of the composition, said mixture is exposed to a high pressure of at least 1400 bar, and preferably at least 1800 bar, for at least 0.1 second. Thus, an exemplary embodiment proposes processing an aqueous alginate-based composition by using high-pressure, and more precisely exposing the aqueous composition to a pressure of at least 1400 bar, in order to improve the characteristics of the envelope obtained after gelation of the aqueous composition.

The inventors have indeed found, in a surprising and unexpected way, that exposing the aqueous composition to a high pressure of more than 1400 bar improves the mechanical strength of the casing, and in particular the resistance to torsion, traction and penetration, and moreover, an improvement in the adhesion between the casing and the food preparation around which it has zo been applied by co-extrusion is observed.

According to the inventors, one hypothesis that could explain this phenomenon is that high pressures would modify the orientation of the macro-molecules constituting the alginate and/or influence the kinetic properties of exchange between the cations of the alginate and the calcium ions, which would increase the affinity of the alginate with the calcium ions, or in other words the capacity of the alginate to trap the calcium ions.

It should also be noted that advantageously, since said mixture is to be placed in a flexible case for exposure to high pressure, it is generally not necessary to repackage the composition in another container.

In a particular embodiment, in said high pressure exposure step, said composition is exposed to a pressure of at least 2000 bar for at least 0.1 second.

In a particular embodiment, in said high pressure exposure step, said composition is exposed to a pressure of at least 1400 bar for at least 5 seconds.

In a particular embodiment, in said high pressure exposure step, said composition is exposed to a pressure of at least 1800 bar for at least 3 seconds.

In a particular embodiment, in said high pressure exposure step, said composition is exposed to a pressure of at least 1800 bar for at least 5 seconds. In a particularly advantageous embodiment, in said high pressure exposure step, said composition is exposed to a pressure of at least 4200 bar for at least is 0.1 second.

In addition, the bacterial populations present in the aqueous composition are at least partially inactivated, which makes it possible to stabilise the aqueous composition over one or more months. This makes it possible to use aqueous compositions without preservatives on industrial production lines for sausages or other food products.

In a particular embodiment, before or during said mixing step, at least one polysaccharide is incorporated into said composition with water and alginate, said polysaccharide belonging to the group comprising at least:
modified starch;
guar gum;
locust bean gum;
xanthan gum; and
cellulose derivative.

In a particularly advantageous embodiment, said poly-saccharide is guar gum and said mixture comprises between 2 to 7 w/w % sodium alginate, and preferably between 4 and 5 w/w % sodium alginate, and between 0.5 to 6 w/w %, and preferably between 1.4 and 1.8 w/w %, guar gum.

Advantageously, said alginate has a ratio of mannuronic acid to guluronic acid of less than or equal to 1.3.

According to an exemplary embodiment, said mixture has a pH between 3.8 and 4.2 after said exposure to high pressure.

An aspect of the present disclosure also relates to a method for manufacturing a sausage comprising a step of applying by co-extrusion an aqueous composition essentially comprising water and 2 to 10 w/w % alginate around a food preparation, so as to coat said food preparation, and a step of bringing said coated food preparation into contact with a gelling agent such as calcium chloride, so as to fix an envelope formed from said aqueous composition around said food preparation, characterized in that said composition is exposed to a high pressure of at least 1400 bar, and preferably of at least 1800 bar, for at least 0.1 second, before said co-extrusion application step.

It should be noted that in the context of an exemplary embodiment, said composition may be exposed to high pressure within hours or days of mixing the components of the composition, in order to be packaged in buckets or flexible cases to be delivered to the sausage manufacturing site by co-extrusion, but also well after being packaged, whereby the exposure to high pressure may take place at the sausage production site shortly before the composition is injected into a co-extruder, such as a co-extruder.

An exemplary aspect of the present disclosure also relates to an aqueous composition obtained by the method for preparing an aqueous composition described above, such that the force to be exerted in order to make a 10 mm load rod penetrate a coating envelope at a speed of 3.5 mm/s with the aid of a penetrometer is at least 205 g/cm², said load rod having a diameter of 25 mm and a length of 35 mm, and said envelope being obtained by spreading said composition in such a way as to form a substantially homogeneous layer with a thickness of 0.15 mm and then spraying said layer with a gelling agent.

### LIST OF FIGURES

Other features and advantages will become clearer upon reading the following description of several embodiments of the present disclosure, given as mere illustrative and non-limiting examples, and of the appended drawings among which:
FIG. 1 illustrates the steps of an embodiment of a method for preparing an aqueous composition according to an exemplary embodiment, synoptically;
FIG. 2 is a block diagram representation of the steps of an example method for making a sausage according to an exemplary embodiment from an aqueous composition prepared according to the method steps shown with reference to FIG. 1.

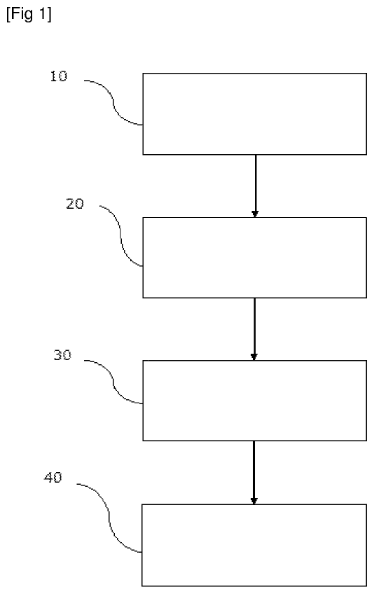

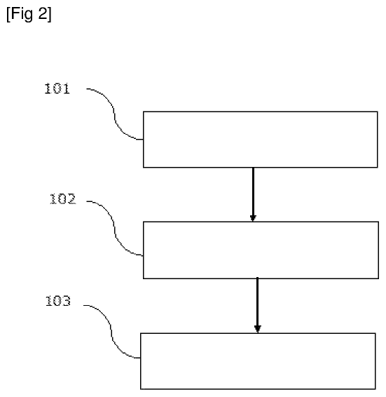

### DETAILED DESCRIPTION OF ILLUSTRATIVE EMBODIMENTS

The steps of an example embodiment of a method for preparing an aqueous composition according to the present disclosure have been illustrated in FIG. 1 as a block diagram.

In a first step (10), 4.5 kg of sodium alginate are mixed in a mixer with 0.4 kg of lactic acid, 0.14 kg of guar gum having a viscosity of 600 cps and 93.5 litres of softened water, for about 5 minutes. In the following, this aqueous composition is referred to as COMPOSITION 1. It should be noted that this aqueous composition advantageously contains no preservative.

This mixture is packaged in airtight bags (step 20) which are placed in the chamber of a high hydrostatic pressure processing equipment marketed, for example, by the company Nc Hiperbaric (registered trademark) during a step 30.

In a step 40, the pressure in the chamber is raised to 2000 bar and the pressure in the chamber is maintained at 4200 bar for 5 seconds.

The chamber is then depressurized to remove the bags from the chamber.

These bags containing the high pressure treated COMPOSITION 1 are then ready for delivery to a sausage production site.

Comparative tests on the use of COMPOSITION 1 exposed or not to high pressures on a sausage co-extrusion line, and for example a co-extrusion line ConPro(registered trademark) marketed by the company Handtmann, or CC215 marketed by the company Vemag or CoeXSkin(registered trademark) of the company Marel, for example, have shown that the strength, and in is particular the torsional strength and the tensile strength, is improved in the case of the high-pressure processed COMPOSITION 1 obtained in step 40.

For these tests, in a step 101, a coating layer consisting of COMPOSITION 1, exposed or not to high pressures, was co-extruded around a meat mixture, which was pushed towards the co-extrusion machine by means of a pusher.

At the exit of the co-extrusion die, a calcium chloride gelling solution was sprayed in a step 102 onto the exiting continuous sausage tube, so as to fix the applied aqueous composition around the meat preparation, which then forms an envelope around the meat.

The continuous tube of sausage is then fed (step 103) into a ConProLink (registered trademark) unit from Handtmann, which simultaneously divides the tube into sausages of constant length by twisting the tube at regular intervals and seals the ends of each sausage by crimping.

In particular, it was found that by using COMPOSITION 1 exposed to high pressure, the continuous sausage tube can be twisted more easily and casings of strings of about ten sausages did not tear under their weight, unlike when using COMPOSITION 1 without having exposed it to high pressure.

Furthermore, it was measured with a Brookfield CT3-V2(registered trademark) penetration testing machine that the penetration resistance of a substantially homogeneous 0.15 mm thick gel layer of the high pressure processed COMPOSITION 1 obtained in step 40 was 236+/−10 g/cm² on average over 6 measurements, when a load rod with a diameter of 25 mm and a length of 35 mm of 10 mm was made to penetrate the layer at a speed of 3.5 mm/s, whereas it was only 163+/−10 g/cm² when the same measurement protocol was applied to a gel layer of thickness 0.15 mm of COMPOSITION 1 which had not been exposed to high pressure. It should be noted that to obtain the 0.15 mm thick layer, COMPOSITION 1 obtained in step 40 was co-extruded around a is “neutral” paste obtained by mixing 18 kg in proportion of VITACEL (registered trademark) Grade L600-10 cellulose fibers, also known as food additive code E460ii, with 2.7 kg of guar gum and 79.3 litres of water, calcium chloride was then sprayed onto the pulp coating layer to gel the aqueous gel and the pulp shell was separated.

It was also found that the adhesion of the meat preparation to the gel-like casing obtained from COMPOSITION 1 was significantly improved if COMPOSITION 1 had been previously exposed to a pressure of 4200 bar for 5 seconds.

A summary table of penetration measurements over 10 mm at a speed of 3.5 mm/s, carried out using a Brookfield CT3-V2 penetrometer and a load rod with a diameter of 25 mm and a length of 35 mm on a gelled layer of thickness 0,15 mm obtained by gelling with calcium chloride an aqueous composition formed of the same compounds in proportion as COMPOSITION 1 and prepared according to various preparation methods according to an exemplary embodiment of the present disclosure, in which the aqueous composition was exposed to pressures between 2000 and 6000 bar for 3 seconds to 3 minutes. These layers were obtained by co-extruding aqueous compositions exposed to high pressure around a “neutral” pulp obtained by mixing 18 kg in proportion of E460ii cellulose fibers, with 2.7 kg of guar gum and 79.3 liters of water, then spraying calcium chloride on the pulp coating layer, and finally separating the gelled envelope from the pulp.

| | Maximum pressure | Duration of | Penetration |
|---|---|---|---|
| | to which the | exposure at | force value in |
| Name of the | composition was | maximum pressure | g/cm² |
| composition | exposed (bar) | (seconds) | (+/− 10 g/cm²) |
| C01 | 2000 | 3 | 214 |
| C02 | 3000 | 3 | 213 |
| C03 | 4200 | 3 | 222 |
| C04 | 4200 | 15 | 222 |
| CO5 | 4200 | 45 | 227 |
| CO6 | 4200 | 90 | 234 |
| C07 | 4200 | 180 | 213 |
| C08 | 5000 | 180 | 213 |
| C09 | 6000 | 180 | 210 |

It can be seen from this table that, within the measurement uncertainties, the measured penetration resistance varies little when the pressure is varied between 2000 and 6000 bar or when the exposure time is varied between 3 seconds and 3 minutes.

In the remainder of the description, results of penetration measurements over 10 mm at a speed of 4.5 mm/s, carried out using a Brookfield CT3-V2 penetrometer and a load rod of 25 mm diameter and 35 mm length on a gel layer of thickness 0,15 mm of an aqueous composition formed from the same compounds in proportion as COMPOSITION 1 and on a gel layer 0.15 mm thick of a second aqueous composition according to an exemplary embodiment of the present disclosure, referred to in the remainder of the description as COMPOSITION 2, prepared by mixing 6 kg of sodium alginate in proportion with 0.4 kg of lactic acid and 93.6 litres of demineralised water. For these tests, two versions of these two compositions were prepared, one exposed to a pressure of 6000 bar for 3 minutes and the other not.

| | Exposure to 6000 bar | |
|---|---|---|
| Composition | pressure for 3 minutes | Penetration force value |
| formulation | (Yes/No) | in g/cm² (+/− 10 g/cm²) |
| Same as | N | 160 |
| COMPOSITION 1 | | |
| Same as | Y | 218 |
| COMPOSITION 1 | | |
| Same as | N | 129 |
| COMPOSITION 2 | | |
| Same as | Y | 230 |
| COMPOSITION 2 | | |

It can be seen from this table that the value of the penetration force is is substantially identical for the two aqueous compositions exposed to high pressure, which seems to indicate that the high pressures act mainly on the properties of the alginate (indeed, what distinguishes the formulations of these two aqueous compositions is the presence or not of guar gum in the formulation).

An exemplary embodiment of the present application is therefore intended in particular to overcome the above-mentioned drawbacks of the state of the art.

An exemplary embodiment provides a technique for preparing an aqueous coating composition intended to be applied by co-extrusion around a food preparation which makes it possible to obtain, after gelling, stronger envelopes which can be twisted and/or suspended without risk of the envelope tearing, and which adhere suitably to the food preparation.

An exemplary embodiment provides such a technique that allows a preservative-free aqueous composition to be stabilized over several weeks or even months.

An exemplary embodiment provides such a technique that is simple to is implement.

An exemplary embodiment proposes such a technique at an economically acceptable cost.

An exemplary embodiment provides such a technique which does not affect the organoleptic properties or the colour of the sausages.

Although the present disclosure has been described with reference to one or more examples, workers skilled in the art will recognize that changes may be made in form and detail without departing from the scope of the disclosure and/or the appended claims.

1. A method comprising:
preparing an aqueous coating composition to be applied by co-extrusion around a food preparation and brought into contact with a gelling agent, such as calcium chloride, in order to form an envelope around said food preparation, said composition essentially comprising water and comprising 2 to 10 w/w % alginate, wherein preparing comprises, mixing at least the water and the alginate of the composition, and after the mixing, exposing said mixture to a high pressure of at least 1400 bar, for at least 0.1 second

2. The method according to claim 1, wherein in said high pressure exposing, said composition is exposed to a pressure of at least 4200 bar for at least 0.1 second.

3. The method according to claim 1, wherein in said high pressure exposing, said composition is exposed to a pressure of at least 1400 bar for at least 5 seconds.

4. The method according to claim 1, wherein in said high pressure exposing, said composition is exposed to a pressure of at least 2000 bar for at least 3 seconds.

5. The method according to claim 1, wherein, before or during said mixing, at least one polysaccharide is incorporated into said composition with water and alginate, said polysaccharide belonging to the group consisting of:
starch;
guar gum;
carob gum;
xanthan gum;
cellulose derivative.

6. The method according to claim 5, wherein said poly-saccharide is guar gum and said mixture comprises between 2 and 7 w/w % sodium alginate, and between 0.5 and 6 w/w % guar gum.

7. The method according to claim 1, wherein said alginate has a ratio between mannuronic acid and guluronic acid lower than or equal to 1.3.

8. The method according to claim 1, wherein said mixture has a pH between 3.8 and 4.2 after said exposure to high pressure.

9. A method for manufacturing a sausage comprising:
applying by co-extrusion an aqueous composition essentially comprising water and 2 to 10 w/w % alginate around a food preparation, so as to coat said food preparation;
bringing said coated food preparation into contact with a gelling agent so as to fix an envelope formed from said aqueous composition around said food preparation; and
exposing said composition to a high pressure of at least 1400 bar for at least 0.1 second, before said co-extrusion.

10. An aqueous composition obtained by the method for the preparation of an aqueous composition according to claim 1, characterised in that to make a load rod penetrate 10 mm into a coating envelope at a speed of 3.5 mm/s with the aid of a penetrometer is at least 205 g/cm², said load rod having a diameter of 25 mm and a length of 35 mm and said envelope being obtained by spreading said composition so as to form a substantially homogeneous layer with a thickness of 0.15 mm and then by spraying a gelling agent onto said layer.

11. The method according to claim 1, wherein in said high pressure exposing, said composition is exposed to a pressure of at least 1800 bar for at least 0.1 second.

12. The method according to claim 5, wherein said poly-saccharide is guar gum and said mixture comprises between 4 and 5 w/w % sodium alginate and between 1.4 and 1.8 w/w %, guar gum.

13. The method according to claim 9, wherein the exposing comprises exposing the composition to a pressure of at least 1800 bar for at least 0.1 second.

14. The method according to claim 9, wherein the gelling agent comprises calcium chloride.
